(19) United States
(12) Patent Application Publication
(10) Pub. No.: US 2010/0066252 A1
(43) Pub. Date: Mar. 18, 2010

(54) SPIRAL RF-INDUCTION ANTENNA BASED ION SOURCE FOR NEUTRON GENERATORS

(75) Inventors: Jani Petteri Reijonen, Princeton, NJ (US); Sami K. Hahto, Nashua, NH (US)

Correspondence Address: LAWRENCE BERKELEY NATIONAL LABORATORY, Technology Transfer & Intellectual Propery Managem, One Cyolotron Road MS 56A-120, BERKELEY, CA, 94720, US

(73) Assignee: The Regents of the University of California, Oakland, CA (US)

(21) Appl. No.: 12/425,951

(22) Filed: Apr. 17, 2009

Related U.S. Application Data
(60) Provisional application No. 61/046,307, filed on Apr. 18, 2008.

(51) Int. Cl. H01J 27/02

(52) U.S. Cl. 315/111.81

(57) ABSTRACT

An ion source for the generation of hydrogen or deuterium ions is disclosed, said source suitable for the generation of D-D and D-T neutrons, wherein the body of the ion source is cylindrical, and disposed at one end of the ion source opposite the extraction plate, is a single, spiraled RF coil antenna, in which the spiraled coils are flat.

### CROSS-REFERENCE TO RELATED APPLICATIONS

This application claims priority to Provisional U.S. Patent Application No. 61/046,307 filed Apr. 18, 2008, entitled Spiral RF-Induction Antenna Based Ion Source for Neutron Generators, which application is incorporated herein by reference.

### STATEMENT OF GOVERNMENTAL SUPPORT

The invention described and claimed herein was made in part utilizing funds supplied by the U.S. Department of Energy under Contract No. DE-AC02-05CH11231. The government has certain rights in this invention.

### BACKGROUND OF THE INVENTION

1. Field of the Invention

This invention relates generally to neutron imaging generators, and, more specifically to an improved ion source for such generators incorporating a spiral shaped RF antenna.

2. Description of the Related Art

Neutron generators are used in a variety of applications ranging from material identification for homeland security operations to cancer treatments for medical applications. Potentially orders of magnitudes of higher neutron yield would enable wide use of these neutron generators at various screening applications, like large shipping container screening and airline cargo screening. In the medical field, the high yield would allow fast Boron Neutron Capture Therapy treatments as well as medical isotope production for Positron Emission Tomography (PET).

Both for sealed neutron generator operations and for extremely high current beam injector systems for fusion reactors, an ion source that operates at low pressure with high efficiency (high current density and atomic species fraction with relatively low discharge power) is desirable. A sealed neutron generator imposes special requirement for the ion sources, because by definition the operating gas pressure in the plasma generator region and in the target region of the device is the same.

Currently, RF-induction based plasma generators rely on coil antennas to couple the RF energy to the gas to be ionized within the ion source. This coil antenna is situated either inside the plasma volume or outside, wrapped around the plasma chamber, or above an insulating window formed of a material like quartz or alumina. The former has the disadvantage of a finite life-time due to antenna surface deterioration. The latter has the disadvantage of requiring relatively high operational pressures.

A regular RF-induction ion source can only operate efficiently at relatively high operational gas pressures (>10 m Torr), while at the same time the high voltage target element requires low gas pressures (<5 m Torr) to operate reliably without damaging sparking and glow discharge. High efficiency at low operational pressure is also important for extremely high current beam injector applications. Low pressure operation and high current density will decrease the gas load in the subsequent low energy beam transport (LEBT) system in two ways. First, the ion source extraction aperture can be relatively small in order to minimize the gas flow to the low energy beam transport system and still deliver large quantities of beam current. Second, because the gas pressure in the LEBT is proportional to the pressure in the ion source, lower operational pressures thus means lower pressure in the LEBT system.

### SUMMARY OF THE INVENTION

It has been found that spiral antennas for generation of a plasma in the ion source uses the source geometry more efficiently if the antenna is planar and thus its use does not increase the volume of the ion source. This enables larger uniform plasmas to be formed with small volume and thus higher power density in the source. Another geometric advantage of the spiral antenna is that even large extraction areas can be covered by the antenna, enabling highly uniform plasmas over the extraction region. By using the spiral RF-induction antenna with optimized plasma generator geometry, one can thus greatly enhance the performance and efficiency of the current state of the art RF induction plasma generators. By way of this invention, a single spiral antenna is used in combination with the ion source. While the deployment of two spiral RF antennas positioned opposite each other on the side wall of the ion source was earlier investigated, ultimately the use of the single spiral coil antenna was found to be preferable.

### DESCRIPTION OF THE DRAWINGS

The foregoing aspects and others will be readily appreciated by the skilled artisan from the following description of illustrative embodiments when read in conjunction with the accompanying drawings.

FIG. 1 is a schematic side view of an ion source according to an embodiment of this invention in which a single spiral antenna is deployed.

FIG. 2 is a schematic top view of the ion source of FIG. 1 depicting the RF coil situated atop a quartz window.

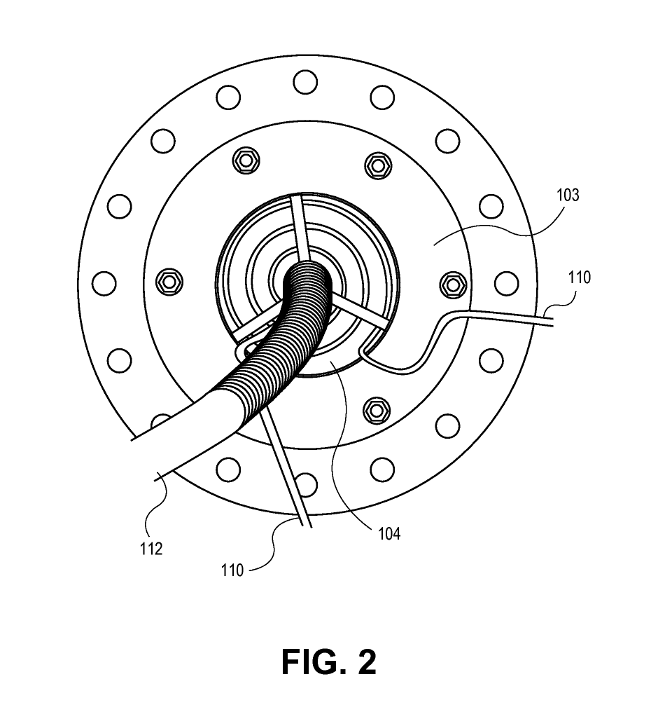

FIG. 3 is a graph comparing the extracted H+ current densities as a function of RF power for a conventional coil antenna and a spiral antenna ion source.

FIG. 4 is a graph which plots extracted H+ current density from a spiral antenna source as a function of source pressure.

FIG. 5 is a chart showing hydrogen ion species extracted from a spiral antenna ion source at 1.2 kW RF power and 15 m Torr source pressure.

FIG. 6 is a three dimensional depiction of the ion source configuration wherein two spiral RF antennas are positioned in opposing relationship on the wall of the source.

### DETAILED DESCRIPTION

By way of this invention, a plasma is generated using a spiral shaped RF-antenna disposed proximate a flat RF-window. This arrangement has been shown to provide high plasma densities at low operating gas pressure. Both properties are needed for sealed or semi-sealed operation.

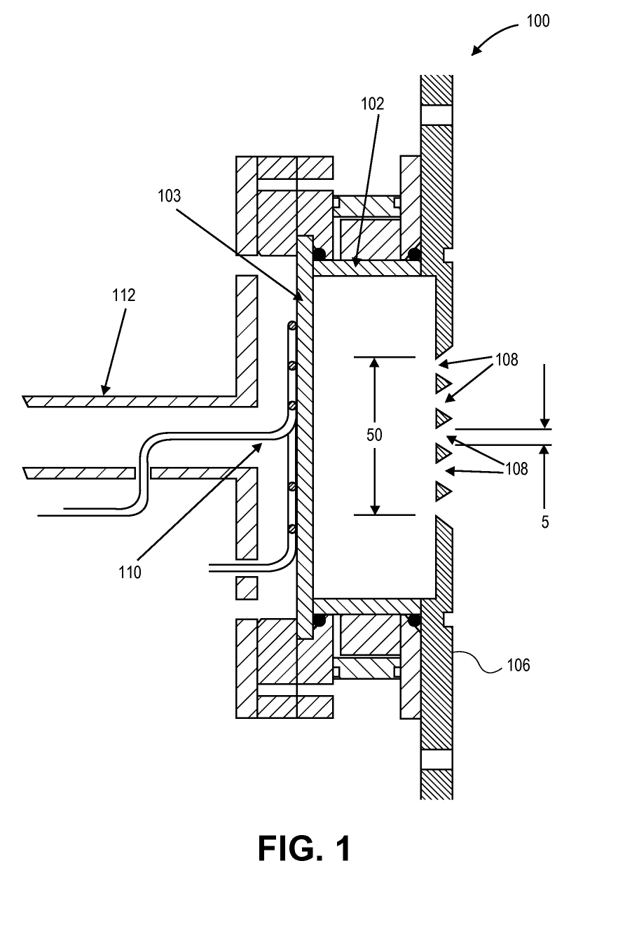

With reference to FIG. 1, an ion source 100 according to this invention is shown, in which a cylindrical alumina (Al₂O₃) plasma chamber 102 is illustrated. At the closed end 103 of chamber 102, a window 104 is provided. The window may be made alternatively from quartz, alumina or sapphire. At the other end of the chamber, facing the downstream target, an extraction plate 106 is provided, said plate 106 including an array of extraction apertures 108 through which ions generated in the plasma formed within the chamber may be extracted. In one embodiment the apertures are provided in the form of a series of parallel slits. Sitting atop the window 104 is a flat, spiral RF antenna 110. As illustrate in the figure, the antenna is a flat antenna having 3.5 turns.

An important component of the new ion source is the cooling of the RF-window. When a good heat conducting insulator material is used, air cooling of the window is sufficient to prevent heat build-up. The frame of the plasma generator and the metal surrounding the window can also be water-cooled. This so called edge-cooling allows the window to reach certain, even temperature levels if the window material is a good conductor of heat, like alumina, or sapphire. In the embodiment of FIG. 1, cooling for the antenna is provided by air cooling source 112. Water cooling for the window is also provided, the details of the cooling arrangement not shown, such cooling arrangement well known in the art.

By way of illustration, for the source of FIG. 1, 5 mm wide extraction slits 108 are depicted covering a 5×8 cm area. An advantage of this configuration is that it allows for the unit to be quite thin, giving it a pancake like appearance. With the antenna moved close to the extraction plane, the source volume is thus made smaller, and the plasma density accordingly increased. As a further advantage of this geometry, where the extraction plate 106 is disposed parallel to the RF antenna, the generated plasma is more uniformly distributed across the chamber in the region proximate the extraction slits.

This large area ion extraction system provides large beam currents for high yield neutron generators, neutral beam injectors or semiconductor applications. The use of the spiral antenna provides a uniform plasma distribution enabling large area extraction with similar ion optics across the entire extraction area. Thus the beam transport is predictable and can be simulated reliably. In one embodiment the span of the RF antenna is co extensive with the area of the extraction apertures. In another embodiment the RF antenna extends over an area which is larger than the area covered by the extraction apertures.

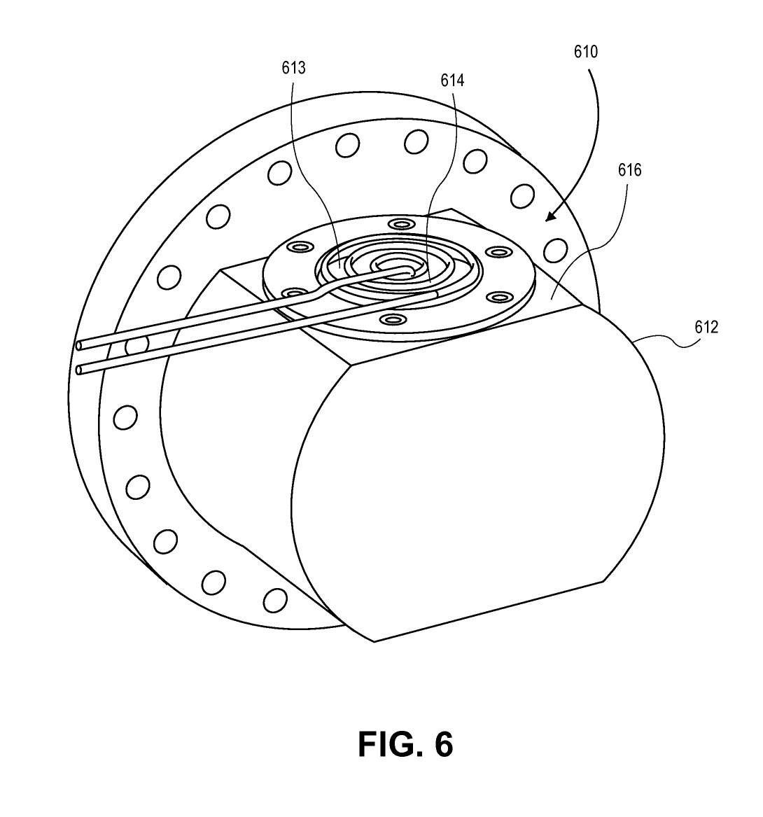

With reference to FIG. 6, a cylindrical ion source 610 (its central axis in line with the beam line), is depicted, source 610 having its open end covered by an extraction plate (not shown) which includes one or more extraction slits positioned along that axis, in the downstream direction of the target. To accommodate two antennas (only top antenna 614 shown), the cylindrical wall of the source is truncated at two, opposing locations, the resultant flat areas 616 of sufficient dimension to accommodate the RF window with its associated spiral RF coil. Due to the need to increase the cylindrical dimension of the source to accommodate the coils and their associated windows, however, the pancake like configuration of the single window source is not possible.

The preferred embodiment illustrated is in the context of a D-D type neutron imaging generator. Neutrons can be used to image fine cracks and other metal pipe deformations in cooling pipes of power-plants and other critical applications such as cargo inspection. For neutron imaging, a bright neutron source is desirable. This means, that for a neutron generator the beam spot size on the target has to be small and the beam power has to be high. In the case of a flat target, this leads to high surface temperatures and low neutron yield. One of the features of the D-D imaging neutron generator developed at the Lawrence Berkeley National Lab is the use of a conical-shaped target, such as described in U.S. Pat. No. 7,342,998. The cone-shape increases the cooling surface area of the target, allowing a small beam spot size projected on the axis of the neutron generator.

It is to be appreciated that the multiple beam ion source of this invention employing a flat, spiral RF antenna can be used in connection with both the generation of gamma ray and neutron beams. In the case of the latter, the ion source gases used are deuterium and/or tritium, which produce D+ and/or T+ ions. In the case of the former for gamma ray generation, hydrogen gas is used as the operating gas to produce H+ ions.

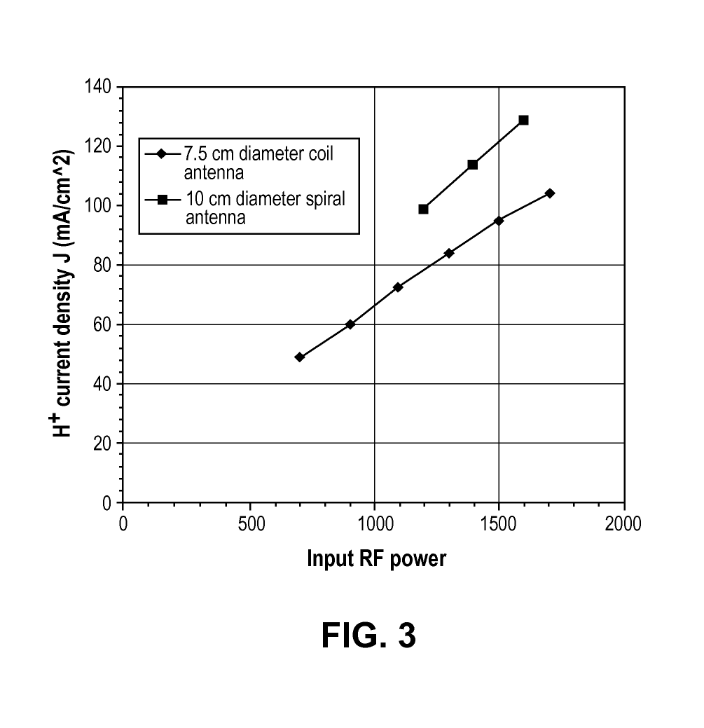

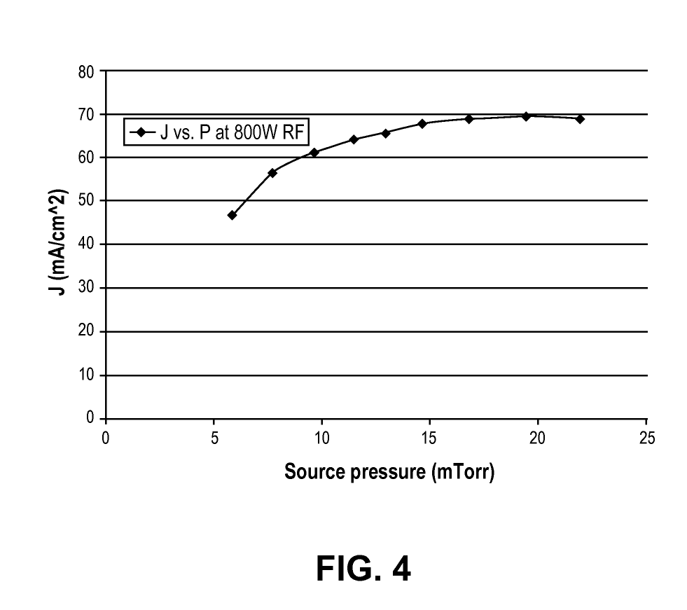

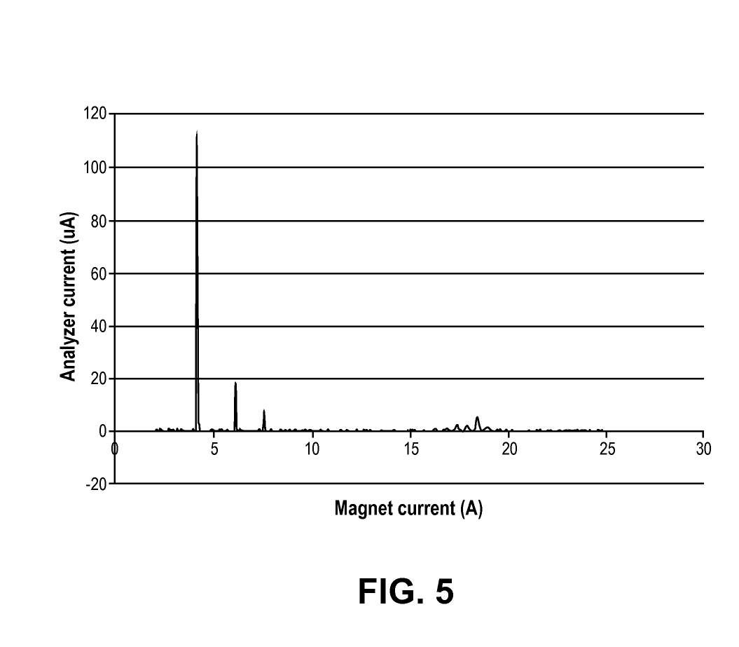

To illustrate the performance obtainable using the flat RF spiral coil of this invention, reference is now made to FIG. 3, a plot of input RF power vs. H+ current density is shown for a conventional RF coil, vs. the flat RF spiral coil of this invention. As evidenced by these results, higher currents are obtained using the flat coil. FIG. 4 is a plot of extracted H+ current density from the spiral antenna source of this invention as a function of source pressure, which shows how the ion source can still be operated with gas pressure approaching 5 mTorr. This efficient low pressure operation is an enabler for sealed tube operation in the neutron generators. FIG. 5 is a plot of hydrogen ion species extracted from an ion source using the spiral antenna of the invention, at 1.2 kW RF power and 15 m Torr source pressure.

The spiral antenna has proven to be an efficient way of coupling RF-energy into a plasma. In this context high efficiency means low operational gas pressures, high atomic hydrogen and hydrogen type gas atomic species fractions and high output current density while operating at low RF-discharge power. This allows a design and fabrication of a sealed D-T or T-T neutron generator that has extremely high efficiency.

The current state of the art in D-T neutron generators is ˜10¹⁰ n/s with ˜1 mA of beam current. The projected neutron output could be ˜10¹² n/s with 100 mA of beam current with the high efficiency, spiral RF-induction antenna based plasma generator of this invention. The main advantages for neutron generator applications of the new spiral antenna based design is that it can generate high current densities at low operational pressures and low discharge powers. Plasma generators with extremely high output currents will also benefit from this new design. For example in fusion applications extremely high current and dimensionally large and uniform positive and negative hydrogen ion beams are needed. The spiral antenna enables efficient use of source geometry and enables construction of larger extraction area ion sources, which have smaller volume, compared to traditional RF coil antenna geometries.

This invention has been described in detail to provide those skilled in the art with information sufficient to apply the principles of the invention and to construct and use such specialized components as are required. It is to be understood the invention can be carried out by different equipment, materials and devices, and that various modifications, both as to the equipment and operating procedures, can be accomplished without departing its scope.

We claim:

1. An ion source in which a spiral RF inductive coil is employed to generate a plasma, the source including:
a. a cylindrical housing, said housing being closed at its first end and having an extraction plate disposed at its second end.
b. a plurality of extraction apertures disposed in said extraction plate, said apertures
providing for the directing of a multiplicity of ion beams towards a downstream target; and,
c. an RF window and associated RF coil disposed at said first closed end of the
cylindrical housing, and opposite said extraction plate, wherein said RF coil is a spiral RF coil.

2. The ion source of claim 1 wherein said spiral RF coil is a flat coil.

3. The ion source of claim 2 wherein the apertures in said extraction plate are extraction slits.

4. The ion source of claim 2 wherein the ion source is a neutron source and the generated plasma is one in which D+ and T+ ions are generated.

5. The ion source of claim 2 wherein the RF window is air cooled.

6. The ion source of claim 5 wherein the RF window is water cooled.

7. The ion source of claim 2 wherein the RF window is made from quartz, alumina, or sapphire.

8. The ion source of claim 2 wherein the extraction plate is disposed a distance from and in a plane parallel to said flat, spiral RF coil.

9. The ion source of claim 8 wherein the area covered by the flat RF spiral coil is larger than the area covered by the extraction apertures of the extraction plate.
